(19) United States
(12) Patent Application Publication
(10) Pub. No.: US 2010/0102141 A1
(43) Pub. Date: Apr. 29, 2010

(54) Support apparatus for water features and installation method

(76) Inventor: Timothy Landvik, Port Angeles, WA (US)

Correspondence Address: MYRL J. SAAREM, 2057 WEST WASHINGTON STREET, CARSON CITY, NV, 89703, US

(21) Appl. No.: 12/290,143

(22) Filed: Oct. 29, 2008

(51) Int. Cl. B05B 17/08

(52) U.S. Cl. 239/17; 29/428

(57) ABSTRACT

An adjustable support apparatus provides for easy installation and proper and precise location of water features, such as fountains, cascade water falls, and the like. After the water features are properly positioned, the installation is secured by bolts or clamps. The nature of the invention provides for keeping the position of water in the feature level.

### BACKGROUND

1. Field of Invention

This invention relates to the apparatus for installing water features, such as waterfalls, fountains and the like in residential and commercial flora displays. The apparatus allows for proper location and height of the features to accomplish intended blending with landscaping, flora, and the like. This invention has particular utility in its ability to provide water features at proper heights and location to produce attractive water fall transfer from water feature to water feature.

2. Description of Prior Art

Water features such as water falls have existed for many years as part of the prior art. There are a multitude of water fall type water features that are commercially available. U.S. Pat. No. 6,209,797, Jennney, describes a cascade waterfall over three simulated leaves which are mounted on three pedestals. The pedestals are constructed of hoops separated by metal rods. The pedestals stand located in a water source pool.

### PRESENT INVENTION —OBJECTS AND ADVANTAGES

The present invention provides for installation of a water feature in an unleveled ground surface, wooden hardware, concrete or the like. The terrain for each feature need not be level with respect to other features. The height and the distance between the water features are adjustable at installation. The invention provides means for keeping the water at proper level in the water feature. Holes can be drilled in wood or concrete to accept the support stake for the apparatus, or the support stake can easily be driven into soil. The apparatus is inexpensive to manufacture and is easy to install. The parts of the apparatus are easily and economically packaged for transport to distribution or installation sites.

### DRAWING FIGURES

FIG. 1 is a plan view of a water feature in the form of a leaf.

FIG. 2 is a cross-sectional view of the present invention taken along line 2-2 of FIG. 1.

FIG. 3 shows a cascading water fall.

FIG. 4 shows a water feature that is a bird bath and fountain.

FIG. 5A and 5B show a cross section and a partial longitudinal view of an extruded plastic tube.

FIG. 6 is a cross section taken along line 6-6 of FIG. 1 and shows an arrangement for providing decorative lighting for a water feature.

### DESCRIPTION

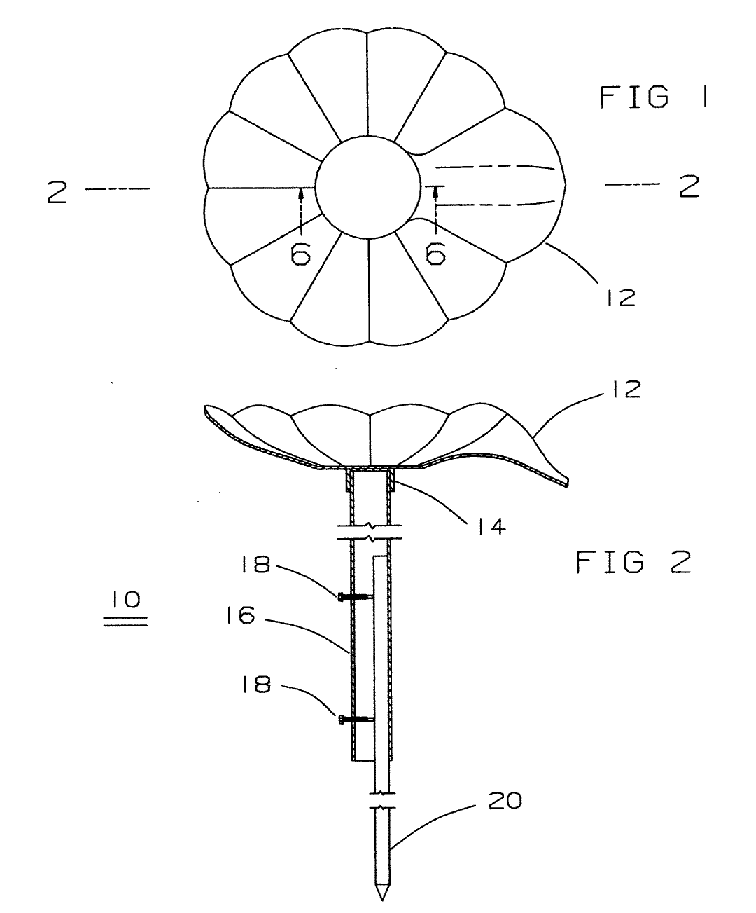

FIG. 1 shows a plan view of a typical water feature in the form of leaf 12, although the feature may take many forms, such as a flower, a bowl or the like. Leaf 12 can be made of a variety of materials such as stainless steel, copper, and the like. The preferred material is plastic.

FIG. 2 is a cross-sectional view taken along line B-B of FIG. 1 and shows a preferred embodiment 10 of the present invention. Attached to the bottom of leaf 12 is a cup shaped receptacle 14. Receptacle 14 can be made of any suitable material and the preferred material is plastic. Receptacle 14 is attached to leaf 12 by brazing, welding, and the like with the preferred method being adhesive bonding or sonic welding. Alternately, if the leaf 12 is vacuum formed plastic, the receptacle may be formed as part of leaf 12.

During installation, an elongated tube 16 of suitable material, such as brass, copper, steel, plastic, and the like, is inserted into receptacle 14. The preferred material for tube 16 is plastic. Tube 16 has attachment screws 18, or other attachment devices, strategically positioned for attachment to elongated stake 20 during installation.

During installation, stake 20 is driven vertically into soil. Conversely, if the apparatus is to be installed on concrete, wood, plastic or the like, proper holes are drilled to accommodate insertion of stake 20. Stake 20 is shown as round but may take on other shapes such as angle iron. After stake 20 is properly secured, assembled parts, leaf 12, receptacle 14, and tube 16 are inserted onto stake 20. Leaf 12, receptacle 14 and tube 16 are then properly positioned vertically and properly rotated to the desired angle, and then attachment screws 18 are tightened against stake 20. The apparatus installation for this water feature is then complete.

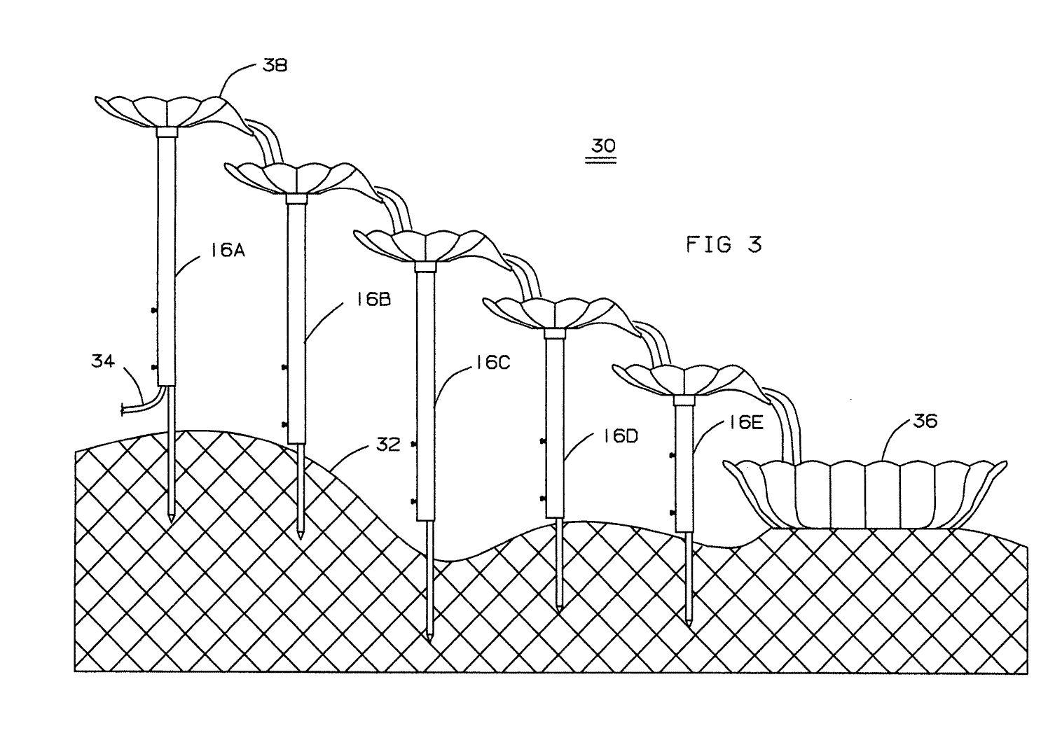

FIG. 3 shows a series of water features arranged as a cascade waterfall 30, mounted on uneven terrain 32. In this figure, tubes 16A, 16B, and 16C are shown to be equal in length. Because of the height adjustment afforded by this invention, proper vertical orientation of the water features can still be obtained. Tubes 16D and 16E are of different lengths. Hose 34 supplies water from a pump, generally mounted in reservoir 36, up through tube 16A and through a central hydraulic fitting in leaf 38, thereby supplying the necessary flow for the waterfall 30. Electric cords may also be installed up through tube 16 to provide lighting or to provide power to a pump, and the like, in order to provide special aesthetic effects.

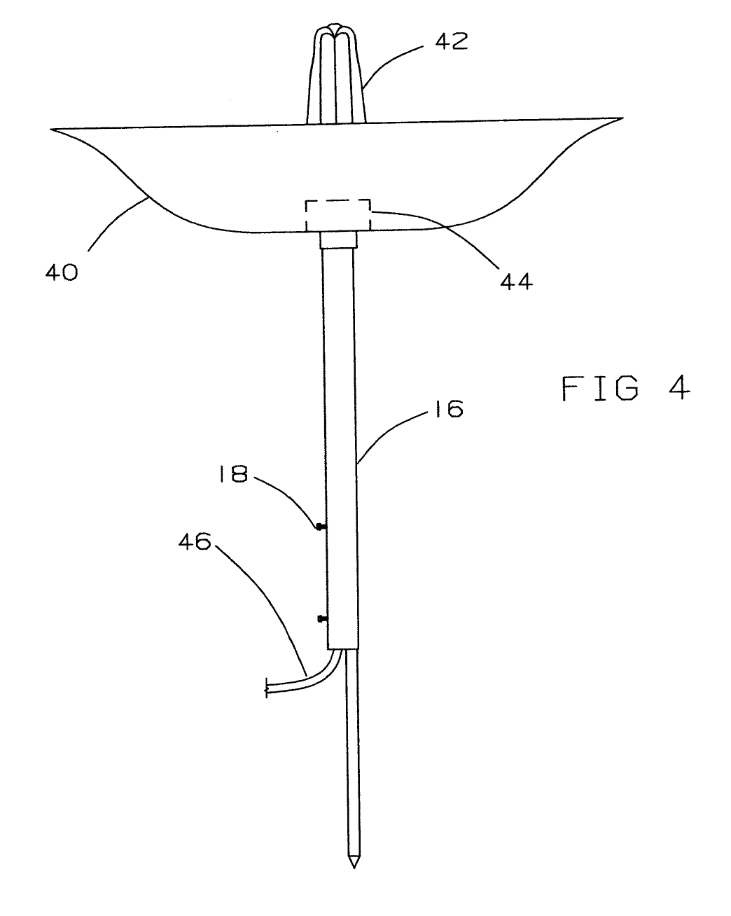

In FIG. 4 the water feature is a bird bath 40 with a central fountain 42. Pump 44 provides the water flow for fountain 42. Electrical cord 46 provides power to pump 44.

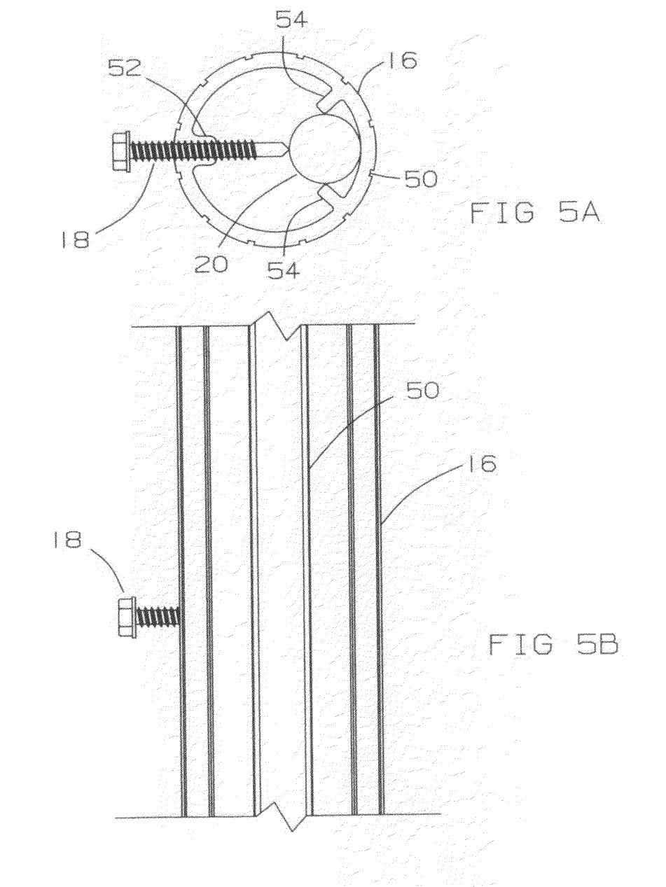

When tube 16 is made from plastic, the preferred method is extrusion. FIGS. 5A and 5B show tube 16 with longitudinal vertical grooves 50 to enhance the apparatus aesthetics. Grooves 50 are easily produced by the extrusion process. Longitudinal rib 52 can also be provided by the extrusion process to enhance the support structure for attachment screw 18. Longitudinal ribs 54 provide a centering means for stake 20.

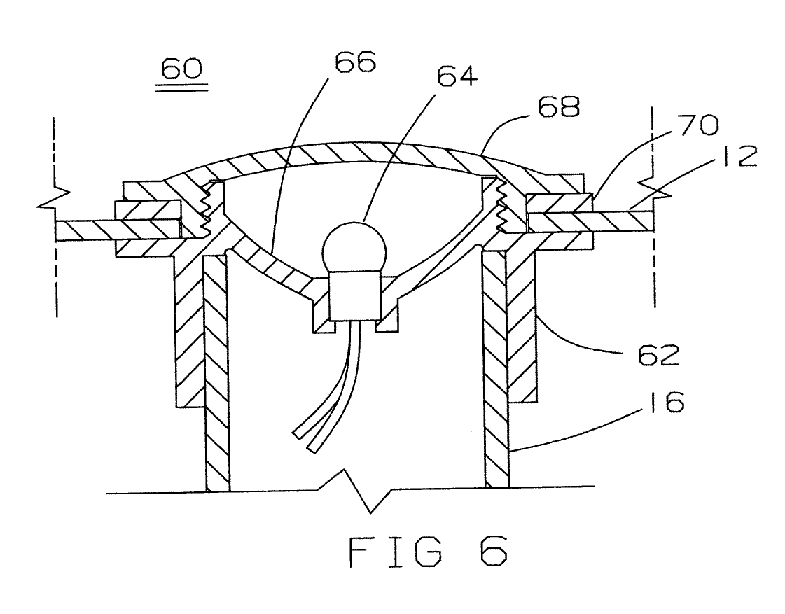

FIG. 6 shows a cross section of a lighting support 60 for a water feature. Elongated tube 16 supports a bulb holder 62. Bulb 64 is shown as an incandescent bulb but may be a light emitting diode, laser, or the like. Bulb 64 is shown as a single unit but may be several units that can be of different color, turned on intermittently, turned on sequentially, and the like. Surface 66 may be fitted with a polished reflective material to produce special optical affects. Transparent lens 68 is secured to bulb holder 62 in such a way as to clamp rubber seal 70 to leaf 12 and therefore sealing water to the confines of leaf 12.

### Conclusions:

Accordingly, this invention offers a means for relatively unskilled individuals to install attractive inexpensive water features. Prior to installation all the components of this invention are essentially separate items. Therefore, an important part of this invention is that all the individual components can be easily and inexpensively packaged for distribution.

It will be appreciated that while particular embodiments of the invention have been shown and described, modifications may be made. It is intended in the claims to cover all modifications that come within the true spirit and scope of the invention.

I claim:

1. A support apparatus for water features, comprising:
a) a water feature, and
b) a receptacle joined to said water feature, and
c) an elongated tube joined into said receptacle, and
d) a stake secured vertically in supporting structure, and
e) attachment means for securing the assembly of said water feature, elongated tube, said receptacle, and said water feature to said stake,
whereby said water feature can be adjusted in elevation and rotation, and secured to a desired position.

2. A support apparatus for water features, comprising:
a) a water feature with an integral receptacle, and
b) an elongated tube joined into said receptacle, and
c) a stake secured vertically in supporting structure, and
d) attachment means for securing the assembly of said water feature, elongated tube, said receptacle, and said water feature to said stake,
whereby said water feature can be adjusted in elevation and rotation, and secured to a desired position.

3. The support apparatus of claim 1 and claim 2 wherein said elongated tube has exterior longitudinal aesthetic grooves.

4. The support apparatus of claim 1 and claim 2 wherein said elongated tube has an interior longitudinal rib to support said attachment means.

5. The support apparatus of claim 1 and claim 2 wherein said elongated tube has interior longitudinal ribs to position said stake.

6. The support apparatus of claim 1 wherein said water feature contains decorative lighting means.

7. The method of installing a water feature apparatus comprising the steps of:
a) installing a stake vertically into a supporting structure, and
b) creating an assembly by inserting an elongated tube into a receptacle of said water feature, and
c) inserting said assembly over said stake, and
d) positioning said assembly vertically and rotationally to a desired location of said water feature, and
e) securing said assembly onto said stake by tightening an attachment means,
whereby said water feature is installed in a desired position and is prepared to receive water from a proper source.
